(19) United States
(12) Patent Application Publication
(10) Pub. No.: US 2007/0215713 A1
(43) Pub. Date: Sep. 20, 2007

(54) LIQUID MATERIAL PLACING METHOD, MANUFACTURING METHOD FOR ELECTRO-OPTICAL DEVICE, ELECTRO-OPTICAL DEVICE AND ELECTRONIC APPARATUS

(75) Inventors: Tsuyoshi Kato, Shiojiri (JP); Tsuyoshi Kitahara, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/679,482

(22) Filed: Feb. 27, 2007

(30) Foreign Application Priority Data
Mar. 15, 2006 (JP) 2006-070697

(51) Int. Cl. A01G 25/09; B05B 17/04; B05B 1/14

(52) U.S. Cl. 239/11; 239/1; 239/548

(57) ABSTRACT

A method for placing a liquid material includes a) discharging the liquid material from a plurality of nozzles into a single region of a substrate during a scan of the substrate performed by a head having a nozzle group including the plurality of nozzles using a first electric pulse, and b) discharging the liquid material into the single region from the plurality of nozzles during the scan using a second electric pulse. The first and second electric pulses are supplied to a pressure controller to control pressure of a liquid chamber communicated with the plurality of nozzles so as to cause the plurality of nozzles to discharge the liquid material. The first and second discharge steps are performed by using the same plurality of nozzles during the same scan.

### BACKGROUND OF THE INVENTION

1. Technical Field

The present invention relates to a liquid material placing method using a droplet discharge method, an electro-optical device and a manufacturing method therefor, and an electronic apparatus.

2. Related Art

Recent interest has been focused on an approach of forming various functional films using a droplet discharge method.

JP-A-2003-159787 is an example of related art.

The example discloses a method for manufacturing a color filter of a liquid crystal display using a droplet discharge method.

Specifically, a liquid material (droplet) containing a color material is discharged from a minute nozzle of a droplet discharge head (hereinafter referred to as “head”) that performs a scan of a substrate so that the liquid material is placed (drawn) in a partition region formed on the substrate.

The placed liquid material is hardened by drying or the like, forming a colored film.

Meanwhile, there are variations in amount of the discharged liquid material (discharge amount) among nozzles, although the variations are small.

The variations cause a problem of irregularity in amount of the placed liquid material (drawing irregularity) depending on a relationship between a region of a substrate and a nozzle.

To reduce such drawing irregularity, in the foregoing example, nozzles that are structurally easy to cause variations in discharge amount are prohibited to be used in the drawing.

In the method according to the foregoing example, when a liquid material is placed in a single partition region, a plurality of scans are performed and nozzles to be used are changed for each of the scans.

This is aimed at statistically reducing the characteristic difference among nozzles by increasing the number of nozzles used for each partition region.

However, the method of increasing the number of nozzles used for each partition region is disadvantageous in terms of effective use of nozzles, resulting in lengthening the drawing time.

### SUMMARY

An advantage of the invention is to provide a liquid material placing method that allows placing a liquid material with slight irregularity in high efficiency of using nozzles, a method for manufacturing an electro-optical device using the liquid material placing method, and an electro-optical device and an electronic apparatus manufactured by this manufacturing method.

A method for placing a liquid material according to one aspect of the invention includes a) discharging the liquid material from a plurality of nozzles into a single region of a substrate during a scan of the substrate performed by a head having a nozzle group including the plurality of nozzles using a first electric pulse, and b) discharging the liquid material into the single region from the plurality of nozzles during the scan using a second electric pulse.

The first and second electric pulses are supplied to a pressure controller to control pressure of a liquid chamber communicated with the plurality of nozzles so as to cause the plurality of nozzles to discharge the liquid material.

The first and second discharge steps are performed by using the same plurality of nozzles during the same scan.

Preferably, a distribution width of discharge amounts in the nozzle group in a discharge using the first electric pulse is defined as a1, a distribution width of discharge amounts in the nozzle group in a discharge using the second electric pulse is defined as a2, and a distribution width of total discharge amounts in the nozzle group in a discharge using both the first and second electric pulses is defined as b, then a1, a2 and b satisfy a relationship: b<a1+a2.

According to the method for placing a liquid material according to one aspect of the invention, a droplet (liquid material) discharged by the first electric pulse and a droplet (liquid material) discharged by the second electric pulse are placed into a single partition region by the same scan.

Although discharged from the same nozzle, both droplets represent different characteristics from each other with regard to characteristics of variations in discharge amount as compared with other nozzles, and therefore can be considered as if they were discharged from different nozzles.

As a result, variations in discharge amount among nozzles in the aforementioned scan are substantially reduced, allowing a liquid material to be placed with slight irregularity.

Preferably, the first and second electric pulses each include a first sub-pulse for reducing pressure of the liquid chamber, a second sub-pulse maintaining an electric potential set at the end-point of the first sub-pulse, and following the second sub-pulse, a third sub-pulse for pressurizing the liquid chamber to cause the nozzles to discharge the liquid material.

In this case, the first and second electric pulses differ from each other in at least a time component of the second sub-pulse.

According to the method for placing a liquid material according to one aspect of the invention, the second sub-pulse, on which distributions of variations of discharge amounts highly depend, differs between the first and second electric pulses.

Therefore, the above-mentioned effects can be preferably obtained.

A method for manufacturing an electro-optical device having a functional film according to another aspect of the invention includes placing the liquid material onto the substrate using the aforementioned liquid material placing method, and hardening the placed liquid material to form the functional film.

According to the method for manufacturing an electro-optical device according to another aspect of the invention, a functional film as a constituent element of the electro-optical device is formed using the aforementioned liquid material placing method.

Therefore, it is possible to efficiently manufacture an electro-optical device with a functional film with slight irregularity among regions on a substrate.

An electro-optical device according to a further aspect of the invention includes a functional film as a constituent element.

The functional film is formed by, during a scan of a substrate performed by a head having a nozzle group including a plurality of nozzles, supplying electric pulses to a pressure controller to control pressure of a liquid chamber communicated with the plurality of nozzles so as to cause the plurality of nozzles to discharge the liquid material into a single region of the substrate and hardening the discharged liquid material.

In this case, a first discharge and a second discharge of the liquid material into the single region are performed using first and second electric pulses, respectively, and the first discharge using the first electric pulse and the second discharge using the second electric pulse are performed by using the same plurality of nozzles and the same scan.

In formation of a functional film constituting an electro-optical device according to the further aspect of the invention, a droplet (liquid material) discharged by the first electric pulse and a droplet (liquid material) discharged by the second electric pulse are placed into a single partition region by the same scan.

Although discharged from the same nozzle, both droplets represent different characteristics from each other with regard to characteristics of variations in discharge amount as compared with other nozzles, and therefore can be considered as if they were discharged from different nozzles.

As a result, variations in discharge amount among nozzles are substantially reduced, allowing a liquid material to be placed with slight irregularity.

In other words, an electro-optical device according to the further aspect of the invention includes a functional film with slight irregularity, and therefore has high quality.

An electronic apparatus according to a still further aspect of the invention includes the foregoing electro-optical device.

The electronic apparatus according to the still further aspect of the invention includes the foregoing electro-optical device, and therefore has advantages of high quality and high manufacture efficiency.

### BRIEF DESCRIPTION OF THE DRAWINGS

The invention will be described with reference to the accompanying drawings, wherein like numbers reference like elements.

FIG. 1 is a schematic view showing the overall structure of a droplet discharge device.

FIG. 2 is a plan view showing a discharge surface of a head.

FIG. 3 is a main portion sectional view showing one example of the internal structure of a head module.

FIG. 4 is a block diagram showing the electric structure of a droplet discharge device.

FIG. 5 is a timing chart showing one example of a drive signal.

FIGS. 6A and 6B are main portion sectional views showing the internal structure of a head module in the process of pressure control.

FIG. 7 is a graph showing one example of distributions of discharge amounts in a nozzle row.

FIG. 8 is a schematic sectional view showing the main portion structure of a liquid crystal display.

FIG. 9 is a schematic perspective view showing a portable information-processing device.

FIG. 10A is a plan view showing the scanning position of a head module with respect to a substrate in a first scan.

FIG. 10B is a plan view showing the scanning position of the head module with respect to the substrate in a second scan.

FIG. 11A is a plan view schematically showing the placing positions of a liquid material into partition regions in the first scan.

FIG. 11B is a plan view schematically showing the placing positions of the liquid material into the partition regions in the second scan.

FIG. 12 is a timing chart showing the structure of a drive signal according to a first modification.

FIG. 13 is a timing chart showing the structure of a drive signal according to a second modification.

### DESCRIPTION OF EXEMPLARY EMBODIMENT

A preferred embodiment of the invention will be described below.

It should be noted that an embodiment to be described in the following is a preferred specific embodiment of the invention to which various technically preferable limitations are added, but the scope of the invention is not limited to those limitations unless otherwise stated in the following description.

In the drawings referred to in the following description, contraction scales of members and parts may differ vertically and horizontally from the actual contraction scale for ease of understanding.

### Droplet Discharge Device

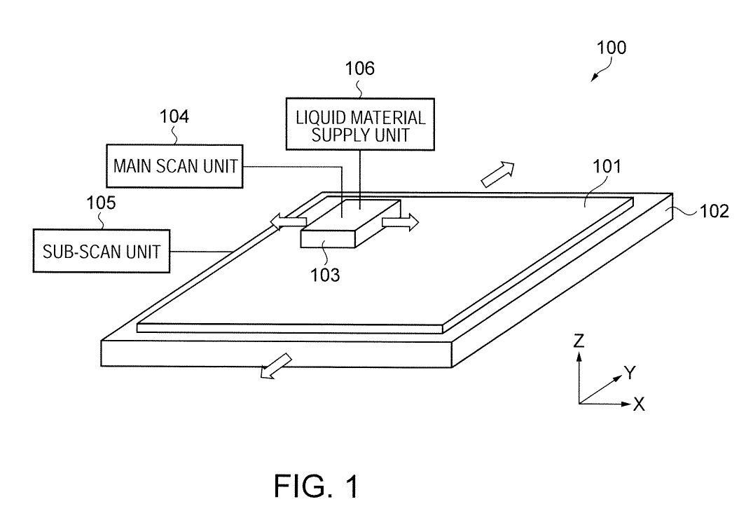

Initially, referring to FIGS. 1, 2 and 3, the mechanical structure of a droplet discharge device according to one embodiment of the invention will be described.

FIG. 1 is a schematic view showing the overall structure of a droplet discharge device.

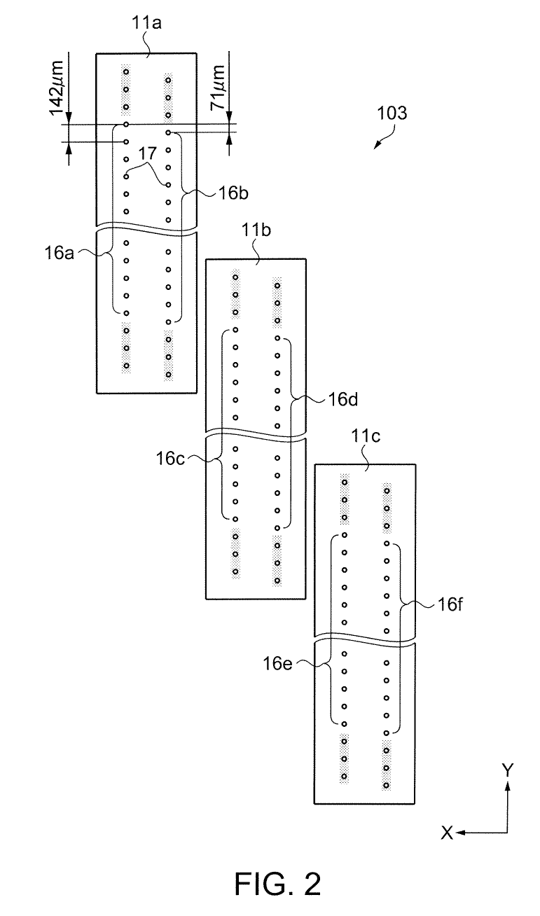

FIG. 2 is a plan view showing a discharge surface of a head.

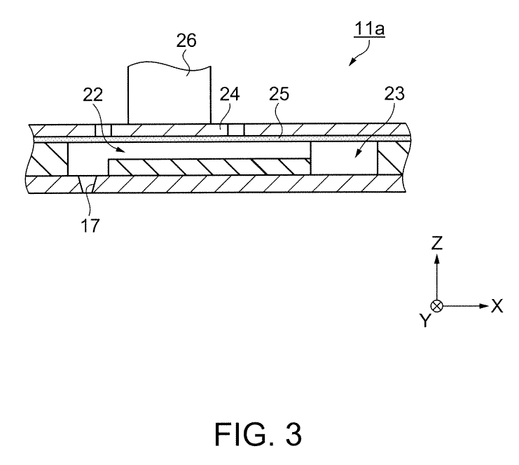

FIG. 3 is a main portion sectional view showing one example of the internal structure of a head module.

Referring to FIG. 1, a droplet discharge device 100 includes a mounting stage 102 on which a substrate 101 is mounted, a head 103 that discharges a liquid material, and a liquid material supply unit 106 that supplies the liquid material to the head 103.

The head 103 is mounted to the main body (not shown) with a main scan unit 104 provided therebetween in such a manner so as to be movable forward and backward (main scanning) in an X axis direction with respect to the stage 102.

The mounting stage 102 is mounted to the main body (not shown) with a sub-scan unit 105 provided therebetween in such a manner so as to be movable forward and backward (sub-scanning) in a Y axis direction with respect to the head 103.

The liquid material supply unit 106 can supply a plurality of kinds of liquid materials to the head 103.

As the liquid material used, water and organic solvents, and solutions of these substances, and, in addition, liquids with solid fine particles dispersed therein and the like can be employed.

The head 103 has a surface that faces the mounting stage 102 (discharge surface).

Mounted on the discharge surface are a plurality of head modules 11a, 11b and 11c as shown in FIG. 2.

Provided in the head modules 11a to 11c are nozzles 17.

The nozzles 17 are arranged in lines in a direction (Y axis direction) perpendicular to the main scanning direction, constituting nozzle rows 16a to 16f as nozzle groups.

The nozzle rows 16a to 16f of this embodiment each include 160 nozzles.

Provided on both ends of the nozzle rows 16a to 16f are nozzles shown with half-tone dot meshing provided thereover.

These nozzles are dummy nozzles, which are actually not used.

In the nozzle rows 16a to 16f, nozzles are arranged at a nozzle pitch of 142 μm, and have such a positional relationship that nozzles of one nozzle row are shifted from those of the adjacent row by half the nozzle pitch.

As a result, when the head 103 is moved in the X axis direction for the main scanning, this positional relationship causes the scanning locus to be drawn continuously at a pitch of 71 μm.

The head module 11a (and also the head modules 11b and 11c) has the internal structure as shown in FIG. 3.

Specifically, the head module 11a includes a cavity 22 that is a liquid chamber communicated with each nozzle 17, and a reservoir 23 that is a common chamber for a pair of nozzle rows 16a and 16b that are each communicated with the cavity 22.

The cavity 22 has a top cover 24 that is movable by a flexible film 25.

The internal pressure of the cavity 22 is controlled by the drive of a piezoelectric element 26, which functions as a pressure controller, joined to the top cover 24.

The pressure of the cavity 22 is more specifically controlled using electric pulses supplied to the piezoelectric element 26.

This pressure control permits a liquid material in the cavity 22 to be discharged from the nozzle 17 (details will be described later).

Thus, control of supply/non-supply of electric pulses sent in synchronization with the scanning of the head 103 is performed for each nozzle 17, enabling a liquid material to be placed (drawn) in an arbitrary region on the substrate 101.

In addition to the head modules 11a to 11c, other head modules, which are not shown, are mounted on the head 103. These other head modules are provided in correspondence to different kinds of liquid materials from those of the head modules 11a to 11c.

The structure of a droplet discharge device is not limited to the above-described embodiment.

For example, the mounting stage 102 may be moved forward and backward in the XY direction under the condition where the head 103 is fixed.

The head 103 also may be moved forward and backward in XY directions under the condition where the mounting stage 102 is fixed.

In addition, the nozzle pitch of the nozzle rows 16a to 16f may be altered, and the extending direction of the nozzle rows 16a to 16f may be tilted toward the Y axis direction.

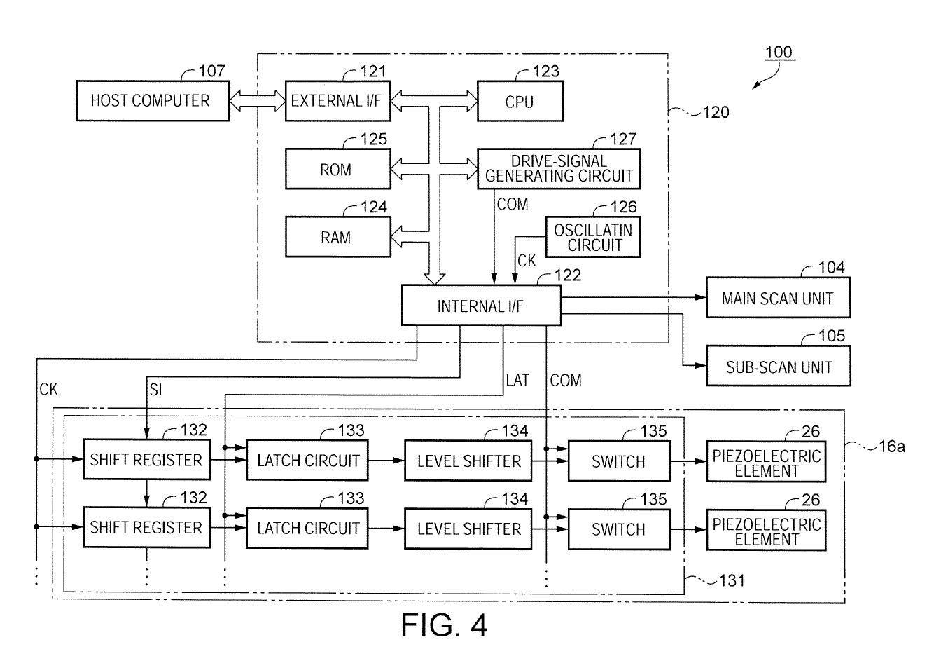

Next, referring to FIGS. 4, 5 and 6, the electric structure of the droplet discharge device and discharging droplets using electric pulses will be described.

FIG. 4 is a block diagram showing the electric structure of the droplet discharge device.

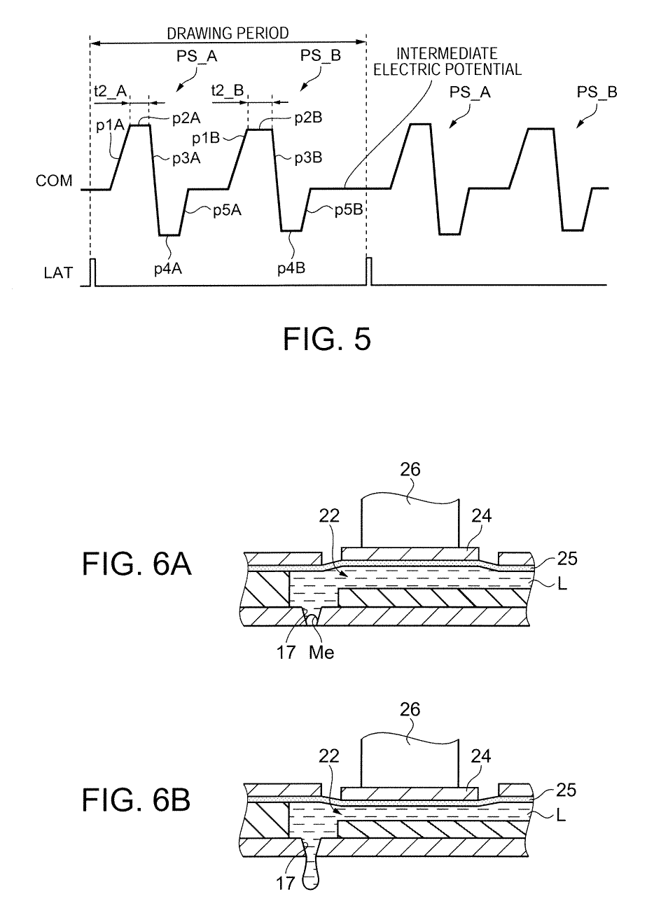

FIG. 5 is a timing chart showing one example of a drive signal.

FIGS. 6A and 6B are main portion sectional views showing the internal structure of the head module in the process of pressure control.

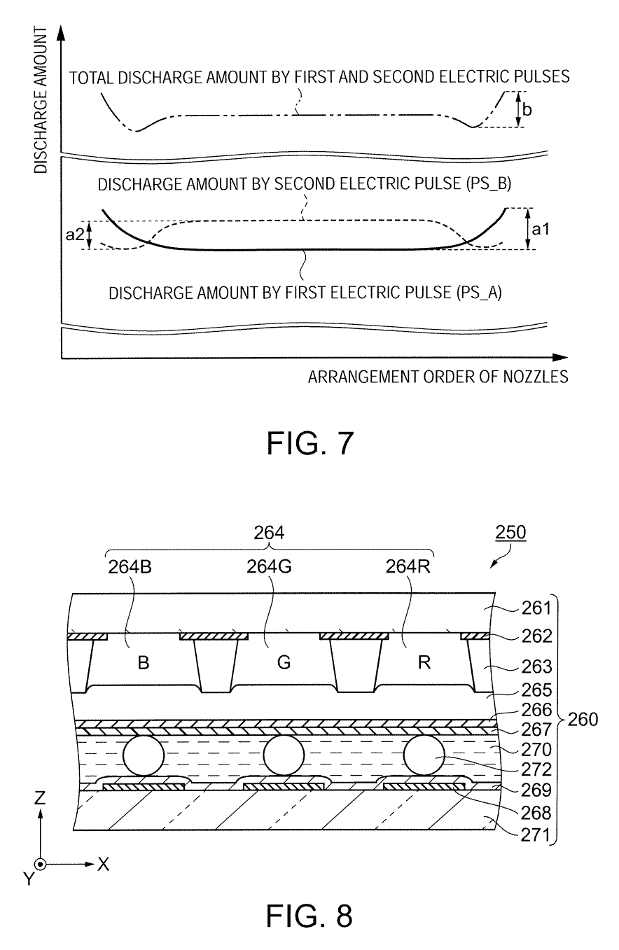

FIG. 7 is a graph showing one example of distribution of discharge amount in the nozzle row.

Referring to FIG. 4, the droplet discharge device 100 includes a control section 120 that performs scanning control and discharge control for each of the nozzle rows 16a to 16f (see FIG. 2).

The control section 120 is coupled through an external interface (I/F) 121 to a host computer 107, and is coupled through an internal I/F 122 to a head drive circuit 131 provided for each of the nozzle rows 16a to 16f, the main scan unit 104 and the sub-scan unit 105.

The control section 120 has a central processing unit (CPU) 123, a random access memory (RAM) 124 that functions as work memory or buffer memory of the CPU 123, a read only memory (ROM) 125 that stores various types of control information, an oscillating circuit 126 for generating a clock signal (CK), and a drive-signal generating circuit 127 for generating a drive signal (COM) including first and second electric pulses PS_A and PS_B (see FIG. 5).

A head driving circuit 131 has a shift register 132, a latch circuit 133, a level shifter 134 and a switch 135, corresponding the piezoelectric element 26 that is provided for each nozzle.

The host computer 107 transmits to the control section 120 so-called bit mapped drawing pattern data that represents arrangement of droplets on a surface on which a pattern is to be drawn.

The CPU 123 decodes the drawing pattern data to generate nozzle data that is on/off information for each nozzle.

The nozzle data is converted into a serial signal (SI), and is transmitted to the shift register 132 in synchronization with the clock signal (CK).

The nozzle data transmitted to the shift register 132 is latched at a timing when a latch signal (LAT, see FIG. 5) is inputted to the latch circuit 133, and is, in the level shifter 134, converted into a gate signal for the switch 135. Thus, if the nozzle data is “ON”, the switch 135 opens for the drive signal (COM, see FIG. 5) to be supplied to the piezoelectric element 26, whereas if the nozzle data is “OFF”, the switch 135 closes.

The drive signal (COM) has the first and second electric pulses PS_A and PS_B connected with an intermediate electric potential in one drawing period set at a timing in synchronization with the main scanning, as shown in FIG. 5.

If the nozzle data for one nozzle is “ON”, the piezoelectric element 26 corresponding to the nozzle receives the first and second electric pulses in a series manner.

As a result, pressure control of the corresponding cavity 22 is performed.

The first electric pulse PS_A has a first sub-pulse p1A for raising the voltage from the intermediate electric potential by charging, a second sub-pulse p2A for maintaining the electric potential set at the end-point of the first sub-pulse, a third sub-pulse p3A for lowering the voltage from the electric potential maintained by the second sub-pulse by discharging, a fourth sub-pulse p4A for maintaining the electric potential set at the end-point of the third sub-pulse p3A, and a fifth sub-pulse p5A for raising the voltage from the electric potential maintained by the fourth sub-pulse p4A to the intermediate electric potential by charging.

When the first sub-pulse p1A is supplied to the piezoelectric element 26, the cavity 22 expands to increase the volume, reducing the internal pressure (pressure reduction process), which causes a meniscus Me of a liquid material L to be drawn inward in the nozzle 17, as shown in FIG. 6A.

The first sub-pulse p1A induces Helmholtz resonance in a flow path system including the cavity 22.

While the second sub-pulse p2A is supplied to the piezoelectric element 26, the volume and the internal pressure of the cavity 22 increase and decrease in accordance with the Helmholtz resonance.

When the third sub-pulse p3A is supplied to the piezoelectric element 26, the cavity 22 is contracted to decrease the volume, raising the internal pressure (pressurizing process), which causes the liquid material L to be ejected from the nozzle 17, as shown in FIG. 6B.

The ejected liquid material L flies as a droplet and is placed on the substrate 101 (see FIG. 1).

The electric potential level lowered by the third sub-pulse p3A is maintained by the fourth sub-pulse p4A, and is restored to the intermediate electric potential by the fifth sub-pulse p5A.

In addition to restoring the electric potential, the fifth sub-pulse p5A undertakes a role of forcibly denying the effect of the Helmholtz resonance induced by the third sub-pulse p3A.

A time component: t2_A of the second sub-pulse p2A performs a role of defining the timing of a phase difference between the Helmholtz resonance induced by the first sub-pulse p1A and that induced by the third sub-pulse p3A.

The phase difference between the both resonances alters the behavior of a liquid material ejected from the nozzle 17 by the third sub-pulse p3A.

Therefore, the time component: t2_A is one of important factors with regard to the amount (discharge amount) and the velocity of droplets.

The discharge amount is affected by variations in structure of the vicinity of the cavity 22 and the positional relationship between the reservoir 23 and the cavity 22.

The discharge amount thus have variations among the nozzles 17 that perform discharge.

FIG. 7 shows distributions of discharge amounts for one nozzle row, taking the arrangement direction of the nozzles 17 as the horizontal axis.

In this example, the discharge amounts corresponding to the first electric pulse PS_A have a distribution such that the discharge amounts are relatively larger near the end of the nozzle row by a distribution width of a1 (difference between the minimum and maximum values).

Note that FIG. 7 shows the discharge amounts when droplets are discharged simultaneously from all the nozzles 17 of the nozzle row.

The second electric pulse PS_B supplied to the piezoelectric element 26 following the first electric pulse PS_A has the same structure as in the first electric pulse PS_A.

Specifically, the second electric pulse PS_B has a first sub-pulse p1B for raising the voltage from the intermediate electric potential by charging, a second sub-pulse p2B for maintaining the electric potential set at the end-point of the first sub-pulse, a third sub-pulse p3B for lowering the voltage from the electric potential maintained by the second sub-pulse by discharging, a fourth sub-pulse p4B for maintaining the electric potential set at the end-point of the third sub-pulse p3B, and a fifth sub-pulse p5B for raising the voltage from the electric potential maintained by the fourth sub-pulse p4B to the intermediate electric potential by charging.

The roles of the sub-pulses p1B to p5B are the same as those of the sub-pulses p1A to p5A of the first electric pulse PS_A; however, the sub-pulses p1A to p5A partially differ from the sub-pulses p1B to p5B in their voltages and time components.

In particular, the time component: t2_A of the second sub-pulse p2A differs from the time component: t2_B of the second sub-pulse p2B.

This difference causes the difference in distribution of discharge amounts in a nozzle row (see FIG. 7).

In this example, the discharge amounts by the second electric pulse PS_B have a distribution such that the discharge amounts are relatively smaller near the end of the nozzle row by a distribution width of a2 (difference between the minimum and maximum values).

As shown in FIG. 7, there tends to be a definite difference in distribution of discharge amounts in the nozzle row between the droplets by the first electric pulse PS_A and the droplets by the second electric pulse PS_B.

The definite difference shows as if the droplets were discharged from nozzles in different rows.

Therefore, focusing attention to the total discharge amount of both droplets, it is considered that variations in discharge amount among nozzles caused by individual electric pulses are statistically reduced.

Accordingly, it is considered that the variations are substantially reduced.

A distribution width b (width between the minimum and maximum values) of the total discharge amounts of both droplets is smaller than the simple sum: a1+a2 of the distribution widths a1 and a2 of the discharge amounts caused by individual electric pulses.

Thus, the droplet discharge device 100 (see FIG. 1) of the embodiment discharges droplets caused by a plurality of kinds of electric pulses in pairs within one drawing period, allowing variations in discharge amount among nozzles to be substantially reduced.

The tendency of distribution of variations in discharge amount has strong dependency particularly on the time components: t2_A and t2_B of the second sub-pulses p2A and p2B.

However, adjustment of the components does not enable completely free control.

The embodiment is designed to make the t2_A, t2_b and other components appropriate individually, head module by head module, making the distribution width b smaller.

It is needless to say that due consideration must be given to the average discharge amount, the average velocity, the discharge stability and the like of droplets in a nozzle row to optimize the sub-pulse components.

### Liquid Crystal Display

Next, referring to FIG. 8, a liquid crystal display as one example of an electro-optical device according to one embodiment of the invention will be described.

FIG. 8 is a schematic sectional view showing the main portion structure of a liquid crystal display.

As shown in FIG. 8, a liquid crystal display 250 as an electro-optical device is a passive matrix liquid crystal display, and has a liquid crystal display panel 260 that includes a color filter substrate (CF substrate) 261 with a plurality of colored films 264, an opposing substrate 271 with a plurality of electrodes 268, and a liquid crystal 270 sandwiched between the CF substrate 261 and the opposing substrate 271.

This liquid crystal display 250 is a display of light-receiving type, and therefore has an illuminating device (not shown) with a light source such as a light-emitting diode (LED) element, an electroluminescence (EL) or a cold-cathode tube on the back surface side of the opposing substrate 271, for example.

Note that the liquid crystal display 250 of the embodiment is not limited to this, and may be, for example, an active matrix liquid crystal display with a switching element such as a thin film transistor (TFT) or a thin film diode (TFD) provided on the opposing substrate 271.

The opposing substrate 271 uses, for example, a transparent resin or glass substrate and has a plurality of transparent electrodes 268 made of indium tin oxide (ITO) on the surface side facing the CF substrate 261.

The electrodes 268 are orthogonal to transparent electrodes 266 made of ITO on the opposing CF substrate 261 and extend in the Y axis direction.

In other words, the liquid crystal display panel 260 has the electrodes 266 and the electrodes 268, which face each other and cross each other at right angles to be arranged in lattice. Portions where the electrodes 266 and the electrodes 268 cross each other at right angles and are lapped one over the other constitute pixel regions for displaying.

The CF substrate 261 uses, for example, a transparent resin or glass substrate and has a light shielding film 262 formed in a predetermined pattern and a bank 263 formed on the light shielding film 262.

Provided in partition regions partitioned by the light shielding film 262 and the bank 263 are colored films 264 corresponding to red (R) green (G) and blue (B), and an overcoat (OC) film 265 as a planarizing layer to cover the colored films 264 and the bank 263.

The electrodes 266 are formed on the OC film 265.

In addition, in order to ensure close contact with the electrodes 266, a thin film such as SiO₂ may further be formed on the OC film 265.

In the liquid crystal display panel 260, the CF substrate 261 as described above and the opposing substrate 271 are provided to face each other at predetermined intervals with gap materials 272 interposed therebetween.

Provided between both substrates 261 and 271 is the liquid crystal 270 sealed by an unshown seal material.

Provided on surfaces encapsulating the liquid crystal 270 of the substrates 261 and 271 are orientation films 267 and 269 for orientating molecules of liquid crystal 270 in a predetermined direction.

It should be noted that although a polarizing plate for polarizing incoming or outgoing light, a phase difference film and the like are typically provided on the front and back surfaces of the liquid crystal display panel 260, descriptions on these units are omitted.

The light shielding film 262 can be manufactured on the CF substrate 261 by using opaque metal such as Cr, Ni or Al, or a compound such as an oxide of the metal as the material by a vapor phase method and a photolithography method.

A photosensitive resin layer with a thickness of about 2 μm is formed on the CF substrate 261 on which the light shielding film 262 is formed by a roll coating method or a spin coating method.

Thereafter, the layer is patterned by a photolithography method.

The bank 263 can thus be obtained.

Liquid materials (coloring liquid) containing three color materials (organic pigment) respectively corresponding to B, G and R are placed in partition regions defined by the bank 263 by the above-described droplet discharge device, and the placed liquid materials are hardened (film formation) by drying or the like (droplet discharge method).

The colored films 264B, 264G and 264R as functional films can thus be formed. Detailed processes of placing the liquid materials will be described later.

The OC film 265 as a functional film may be formed with a liquid material containing transparent acrylic resin by a spin coating method and offset printing.

The film may also be formed by a droplet discharge method.

The electrodes 266 and 268 as functional films may be formed using a vapor phase method and a photolithography method.

The electrodes may also be formed with a dispersion liquid of particles of metal such as Au, Ag or Pt using a droplet discharge method.

A liquid material containing a polyimide resin or the like is provided in pattern using the above-described droplet discharge device 100 to form a resin film.

Thereafter, the formed film is provided with orientation by rubbing process.

The orientation films 267 and 269 as functional films can thus be formed.

### Electronic Apparatus

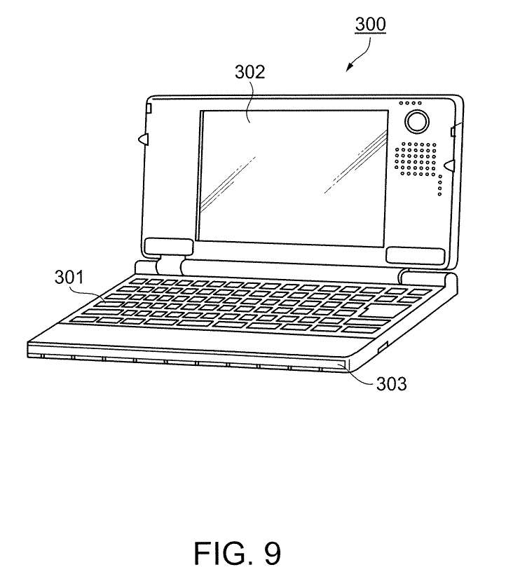

Next, referring to FIG. 9, a portable information-processing device as one example of an electronic apparatus according to the embodiment of the invention will be described.

FIG. 9 is a schematic perspective view showing a portable information-processing device.

A portable information-processing device 300 as an electronic apparatus includes an information-processing device main body 303 with an input keyboard 301, and a display unit 302, as shown in FIG. 9.

The above-mentioned liquid crystal display 250 is used for the display unit 302.

Other examples of the electronic apparatus with the liquid crystal display 250 mounted thereon include cellular phones and wrist watches.

### Liquid Material Placing Method

Next, referring to FIGS. 5, 10A, 10B, 11A and 11B, a liquid material placing method according to the embodiment of the invention will be described by citing the example of formation of colored films on a CF substrate.

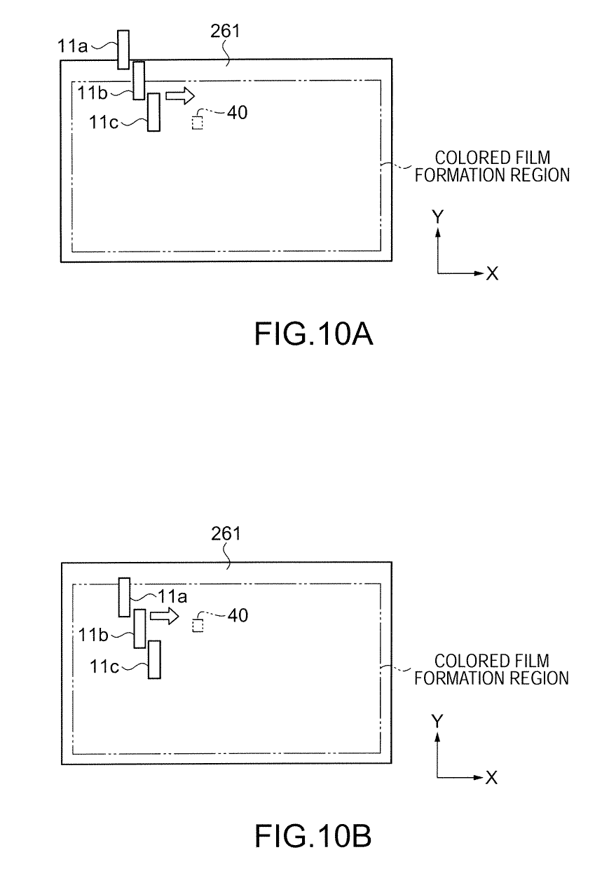

FIGS. 10A and 10B are plan views showing the scanning position of a head module with respect to the substrate in first and second scans, respectively.

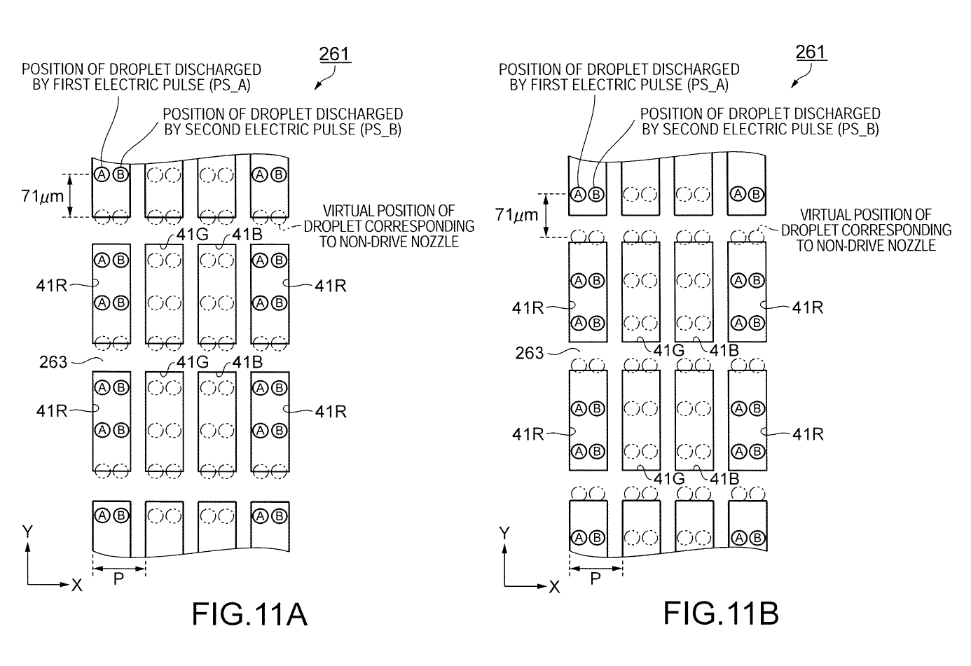

FIGS. 11A and 11B are plan views schematically showing the placing position of a liquid material with respect to partition regions in the first and second scans, respectively.

With reference to FIGS. 10A and 10B, placing a liquid material onto the CF substrate 261 (drawing) is performed using the droplet discharge device 100 (see FIG. 1) by alternately repeating main scanning of the head modules 11a to 11c and moving (sub-scanning) of the CF substrate 261 for a predetermined distance.

For example, droplets (liquid material) are discharged into a region 40 on the CF substrate 261 from nozzles of the head module 11c in the first scan (FIG. 10A), and from nozzles of the head module 11b in the second scan (FIG. 10B).

Partition regions 41R, 41G and 41B each serving as one region partitioned by the bank 263 are provided on the CF substrate 261 regularly in the scanning directions (X and Y axis directions), as shown in FIGS. 11A and 11B.

Here, the partition regions 41R, 41G and 41B are those for forming the colored films 264 of red (R), green (G) and blue (B), respectively (see FIG. 8), constituting a so-called stripe pixel arrangement in the state of the liquid crystal display 250 (see FIG. 8).

Droplets (liquid material) are discharged in synchronization with the scanning position of a nozzle row.

In the embodiment, the drawing period of a drive signal (FIG. 5) is set in correspondence to the a pitch P of arrangement of the partition regions 41R, 41G and 41B in the main scanning direction (X axis direction).

In the examples of FIGS. 11A and 11B that show the positions for placing droplets (liquid material) corresponding to red (R), droplets are discharged in the drawing periods corresponding to the scanning positions on the partition regions 41R, and are not discharged (non-drive) in the drawing periods corresponding to the scanning positions on the partition regions 41G and 41B.

Droplets are not discharged (non-drive) from nozzles positioned to overlap the bank 263, regardless of the drawing period.

In the first scan (FIG. 11A), droplets (indicated by A in the drawing) by the first electric pulse PS_A (FIG. 5) are discharged (first discharge step), and then droplets (indicated by B in the drawing) by the second electric pulse PS_B (FIG. 5) are discharged (second discharge step) into one partition region 41R from two nozzles adjacent to each other.

Further, in the second scan (FIG. 11B), droplets (indicated by A in the drawing) by the first electric pulse PS_A (FIG. 5) are discharged (first discharge step), and then droplets (indicated by B in the drawing) by the second electric pulse PS_B (FIG. 5) are discharged (second discharge step) into the foregoing partition region 41R from two nozzles different from those in the first scan.

A lyophilic treatment such as an O₂ plasma treatment has been applied onto the surface of the CF substrate 261, and therefore droplets discharged (placed) in the first and second scans spread in a wet state in the partition regions 41R, 41G and 41B.

At that point, for the droplets in order to spread uniformly in the partition regions 41R, 41G and 41B, the position for placing droplets by the first scan and the position for placing droplets by the second scan are set to be offset to each other by a distance of half the scanning pitch of nozzles in the Y axis direction.

As described above, each of the droplets (indicated by A in the drawings) discharged by the first electric pulse PS_A (FIG. 5) and each of the droplets (indicated by B in the drawings) by the second electric pulse PS_B (FIG. 5) are placed in a single partition region by the same scan.

Although discharged from the same nozzle, both droplets (indicated by A and B in the drawings) represent different characteristics from each other with regard to variations in discharge amount as compared with other nozzles (see FIG. 7), and therefore can be considered as if they were discharged from different nozzles. As a result, variations in discharge amount among nozzles are substantially reduced, allowing a liquid material to be placed with slight irregularity.

Since droplets are discharged to a single partition region from nozzles that are different between the first and second scans, variations in discharge amount among nozzles are more reduced, allowing a liquid material to be placed with more slight irregularly.

Thus, a liquid crystal display including the colored films 264R, 264G and 264B (see FIG. 8) formed through the above-described processes and a portable information-processing device including the liquid crystal display have high quality.

### First Modification

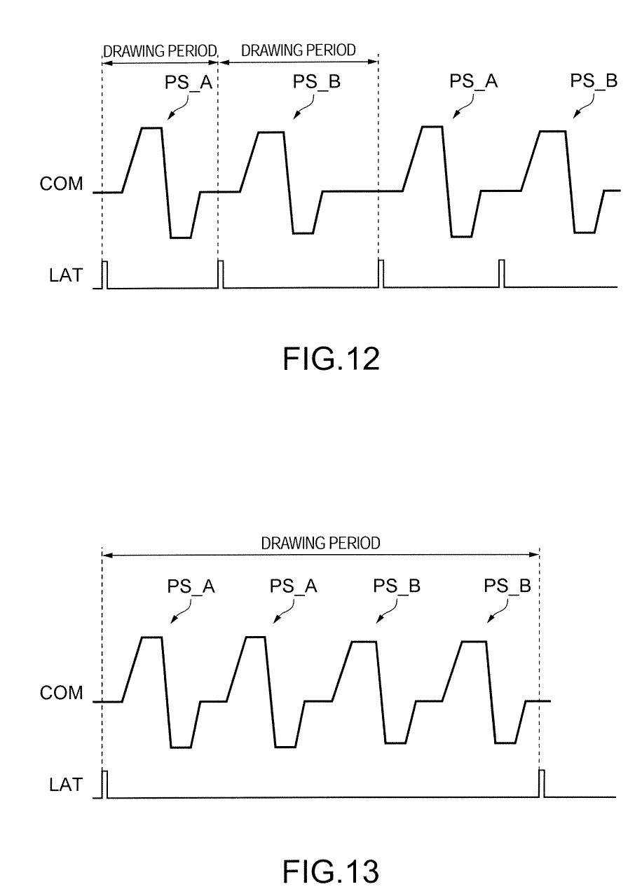

Next, a first modification of the embodiment will be described with a focus on differences from the foregoing embodiment, referring to FIG. 12.

FIG. 12 is a timing chart showing the structure of a drive signal according to the first modification.

In the drive signal (COM) of the first modification, the first electric pulse PS_A and the second electric pulse PS_B having different drawing periods, are arranged alternately.

Like this, the first electric pulse PS_A and the second electric pulse PS_B do not necessarily require the same drawing period. In the case where a liquid material is placed onto the CF substrate by using the drive signal (COM), droplets corresponding to two drawing periods are discharged into a single partition region.

The corresponding drawing pattern data need therefore be prepared.

### Second Modification

Next, a second modification of the embodiment will be described with a focus on differences from the foregoing embodiment, referring to FIG. 12.

FIG. 13 is a timing chart showing the structure of a drive signal according to the second modification.

The drive signal (COM) of the second modification includes two continuous first electric pulses PS_A, PS_A and two continuous second electric pulses PS_B, PS_B in one drawing period.

Like this, the first electric pulse PS_A and the second electric pulse PS_B are not necessarily required to be alternately arranged.

In the case where a liquid material is placed onto the CF substrate by using the drive signal (COM), four droplets per nozzle (corresponding to one drawing period) are discharged in a single partition region.

Placing a liquid material in the single partition region is therefore completed by a single scan.

The present invention is not limited to the above-described embodiment.

Other examples of a functional film formed using the above-described drawing method include a light-emitting film in an organic electroluminescent (EL) display, a fluorescent film in a plasma display, and a conductive film (conductive wiring) and a high-resistance film (resistance element) utilized in an electric circuit unit.

In the above-described embodiment, droplets discharged by two kinds of electric pulses are placed in a partition region on the CF substrate.

However, droplets may also be discharged by combinations of more than two kinds of electric pulses.

Structures of embodiments may be suitably combined one another, omitted, or combined with other unshown structures.

The entire disclosure of Japanese Patent Application No. 2006-70697, filed Mar. 15, 2006 is expressly incorporated by reference herein.

What is claimed is:

1. A method for placing a liquid material, comprising:
a) discharging the liquid material from a plurality of nozzles into a single region of a substrate during a scan of the substrate performed by a head having a nozzle group including the plurality of nozzles using a first one of electric pulses, the electric pulses being supplied to a pressure controller to control pressure of a liquid chamber communicated with the plurality of nozzles so as to cause the plurality of nozzles to discharge the liquid material; and
b) discharging the liquid material into the single region from the plurality of nozzles that are unchanged from the plurality of nozzles in the first discharge step during the scan that is unchanged from the scan in the first discharge step using a second one of the electric pulses.

2. The method for placing a liquid material according to claim 1, wherein, in the case where a distribution width of discharge amounts in the nozzle group in a discharge using the first one of the electric pulses is defined as a1, a distribution width of discharge amounts in the nozzle group in a discharge using the second one of the electric pulses is defined as a2, and a distribution width of total discharge amounts in the nozzle group in a discharge using both the first one of the electric pulses and the second one of the electric pulses is defined as b, then a1, a2 and b satisfy a relationship: b<a1+a2.

3. The method for placing a liquid material according to claim 1, the first one of the electric pulses and the second one of the electric pulses each including a first sub-pulse for reducing pressure of the liquid chamber, a second sub-pulse maintaining an electric potential set at an end-point of the first sub-pulse, and following the second sub-pulse, a third sub-pulse for pressurizing the liquid chamber to cause the nozzles to discharge the liquid material, the first one of the electric pulses and the second one of the electric pulses differing from each other in at least a time component of the second sub-pulse.

4. A method for manufacturing an electro-optical device having a functional film as a constituent element, comprising:
placing the liquid material onto the substrate using the method for placing a liquid material according to claim 1; and
hardening the placed liquid material to form the functional film.

5. An electro-optical device comprising a functional film as a constituent element, the functional film being formed by, during a scan of a substrate performed by a head having a nozzle group including a plurality of nozzles, supplying electric pulses to a pressure controller to control pressure of a liquid chamber communicated with the plurality of nozzles so as to cause the plurality of nozzles to discharge the liquid material into a single region of the substrate and hardening the discharged liquid material, wherein:
a first discharge and a second discharge of the liquid material into the single region are performed using a first one of the electric pulses and a second one of the electric pulses, respectively; and
the first discharge using the first one of the electric pulses and the second discharge using the second one of the electric pulses are performed by using the plurality of nozzles that are unchanged and the scan that is unchanged.

6. An electronic apparatus comprising the electro-optical device according to claim 5.
